(19) United States
(12) Patent Application Publication
(10) Pub. No.: US 2006/0269757 A1
(43) Pub. Date: Nov. 30, 2006

(54) Impact-absorbing durable-surface multi-layer system and method of manufacturing same

(76) Inventor: Robert M. Mackey, Tomball, TX (US)

Correspondence Address: THE MATTHEWS FIRM, 2000 BERING DRIVE, SUITE 700, HOUSTON, TX, 77057, US

(21) Appl. No.: 11/138,872

(22) Filed: May 24, 2005

(51) Int. Cl. B32B 27/40

(52) U.S. Cl. 428/423.1

(57) ABSTRACT

An impact-absorbing durable-surface multi-layer system has a shock-absorbing layer and a wear-layer. Each layer is comprised of a polyurethane binder combined with a rubbery aggregate. An acrylic polymer coating is overlaid on and percolates into the wear-layer, providing UV protection for the polyurethane binder used in the wear-layer. The aggregate in each of the two layers comprises elongated rubber pieces, with the length and width of the shock-absorber layer pieces being sized larger than the length and width of the wear-layer pieces. As an additional feature, a layer of rubber gravel is laid underneath the system. In an alternative embodiment, the coating placed on top of the wear layer may be polyurethane.

### BACKGROUND OF THE INVENTION

### Field of the Invention

This invention relates, generally, to multi-layered systems for protection for humans and even animals from injury from falling on hard, unforgiving surfaces, and more particularly, to systems which have a special purpose of protection for children falling out of playground equipment onto compacted dirt, cement or the like, and, even grass, which would otherwise cause serious, even fatal injuries to such children; and also relates to methods for manufacturing and installing such systems on the surface below where such playground equipment will be used.

### BRIEF DESCRIPTION OF THE DRAWINGS

FIG. 1A is an elevated, cross-sectional, diagrammatic view of the system according to the invention, installed over three different types of base materials;

FIG. 1B is an elevated, cross-section, diagrammatic view of the system according to the invention, installed over a dirt base;

FIG. 1C is an elevated, cross-sectional, diagrammatic view of the system according to the invention, installed over a loose-fill base;

FIG. 1D is an elevated, cross-sectional, diagrammatic view of the system according to the invention, installed over a hard base;

FIG. 1E is an elevated, cross-sectional, diagrammatic view of the prior art systems which create weak seams between adjacent sections of applied adjacent sections which have been interrupted for various reasons; and

FIG. 1F is an elevated, cross-sectional, diagrammatic view of the system according to the invention, using a feathering process for making a smooth transition (no seams) between adjacent sections of the system.

### DETAILED DESCRIPTION OF THE PREFERRED EMBODIMENTS OF THE INVENTION

The following description delineates the vastly improved aspects of the present invention, when compared to the prior art:
Sub-base: The hard and stable base (usually concrete or asphalt) that is required for other poured in place playground safety surfaces because those surfaces are not strong enough to endure without one. The present invention does not require a hard and expensive, shock reducing sub-base.
Underlayment: The shock absorbent layer of the present invention consisting of rubber pieces of a specific elongated shape and a specific size range mixed with a higher percentage of polymer binder. Although the elongated rubber pieces vary in size, a typical rubber piece is 1.25 inches long and 0.25 inches wide.
Wear Layer: The top layer of the present invention consisting of rubber pieces of a specific elongated shape and a specific size range mixed with a polymer binder which creates a porous surface. Although the elongated rubber pieces vary in size, a typical piece is ⅜ inches long and 1.0 millimeters wide. After curing, the layer is saturated with a brightly colored liquid rubber polymer that penetrates the pores, and fills the voids. The liquid rubber solidifies providing extra structural support while also protecting the underlying binder from the UV rays.

### BRIEF DESCRIPTION OF THE INVENTION

The present invention is a wheel chair accessible, seamless, unitary, poured in place rubber safety surface for playgrounds that has the structural integrity to be formed, poured, and troweled directly on the ground (over dirt, clay, sand, gravel, etc.). The hard, shock reducing, and expensive sub-bases that are required for other poured in place playground surfaces are completely unnecessary for the present invention.

Predominate Elements at Issue:

Much Stronger and More Durable: By optimizing the size and shape of the rubber pieces used in the shock absorbent underlayment I have been able to dramatically increase the polymer binder content without compromising shock absorbency. By changing the shape of the rubber pieces in the wear layer and by applying a liquid polymer which fills the wear layer's pores and voids with a strong UV stable rubber compound, I have increased the elongation and flexibility of the wear layer making it much less likely to crack or crumble. The UV stable liquid rubber polymer also protects the underlying binder from UV ray degradation.

More Shock Absorbent and Less Expensive: By eliminating the need for a hard sub-base, cost is dramatically reduced while shock absorbency is dramatically increased (making child safety more affordable). And because the present invention is so strong, it can be installed over inexpensive rubber gravel making it far more shock absorbent than any other unitary playground surface. The present invention dramatically exceeds the Federal fall height shock absorbency standards established by the U.S. Consumer Product Safety Commission. Compliance is documented by the ASTM Test F-1292.

Easier to Install and Repair: By changing the size and shape of the rubber pieces in the wear layer I have made it possible to feather the material which virtually eliminates weak seams. A low viscosity binder penetrates through the pores of the two overlapping feathered layers which permanently binds them into one. Eliminating the weak seam problem makes for easy and strong repairs. It also allows the laborers to patiently focus on workmanship, instead of working rapidly to avoid seams.

No Precise Mixing Ratio's: With the prior art products, the margin for error is extremely small. If too much poly is used, the prior art product will be too hard to provide children protection from serious head injury. If too little poly is used the product will fail very quickly. This compromise between strength and shock absorbency has resulted in many law suits. But with the present invention this liability has been almost eliminated. Both strength and shock absorbency can be maintained with a wide margin for error.

Referring now to the drawings in more detail, FIG's 1A-1F illustrate a multi-layer system according to the invention, having a shock-absorbing layer 12, a wear-layer 14 and a coating 16, illustrated as over-laying three types of typical base layers 10S (soft base, such as dirt or grass), 10L (loose-fill base, such as mulch, pea gravel, sand and rubber gravel) and 10H (hard base, such as concrete, asphalt and compacted rock).

The shock-absorbing layer 12 is applied first over whichever base is present, whether soft, loose-fill, hard, or combinations there. The layer 12 comprises a rubbery aggregate used with a binder, wherein the binder is 13-19% of the total weight of said shock-absorbing layer and the remainder of said shock-absorbing layer is the first rubbery aggregate. The aggregate preferably comprises elongated pieces of rubber that pass through a conventional vibrating sieve system of screens. The elongated pieces of rubber are preferably 3-10 times longer than their width. The screens are sized to accommodate their width. The pieces used in the aggregate pass through an ASTM 0.265 screen but are retained by an ASTM #8 screen. An ASTM 0.265 screen is a 3-mesh screen (9 holes per square inch). An ASTM #8 screen is an 8-mesh screen (64 holes per square inch).

After the elongated rubbery polymeric pieces have been selected for size by the vibrating sieve system, the aggregate is then mixed with a liquid, low viscosity polyurethane binder, preferably comprising either pure Methyl Diphenyl Isocyanate, or polymeric Methyl Diphenyl Isocyanate, or combinations thereof.

The preferred elongated rubber pieces for the aggregate are longer than the width of the screen holes in the sieves through which they must pass to be accepted for the various layers in the system. Such rubber pieces generally pass through the screen only because of the vibration of the screens. Thus, the number passing through the screen is a function of the duration of the vibration process. However, the elongation of the pieces is a valuable feature of the invention with respect to the shock absorbency of the layers.

Although such elongated rubber pieces could come from various sources, one such source is the so-called “buffing” pieces used in removing rubber, typically Styrene Butadiene rubber, from truck tires prior to their being recapped.

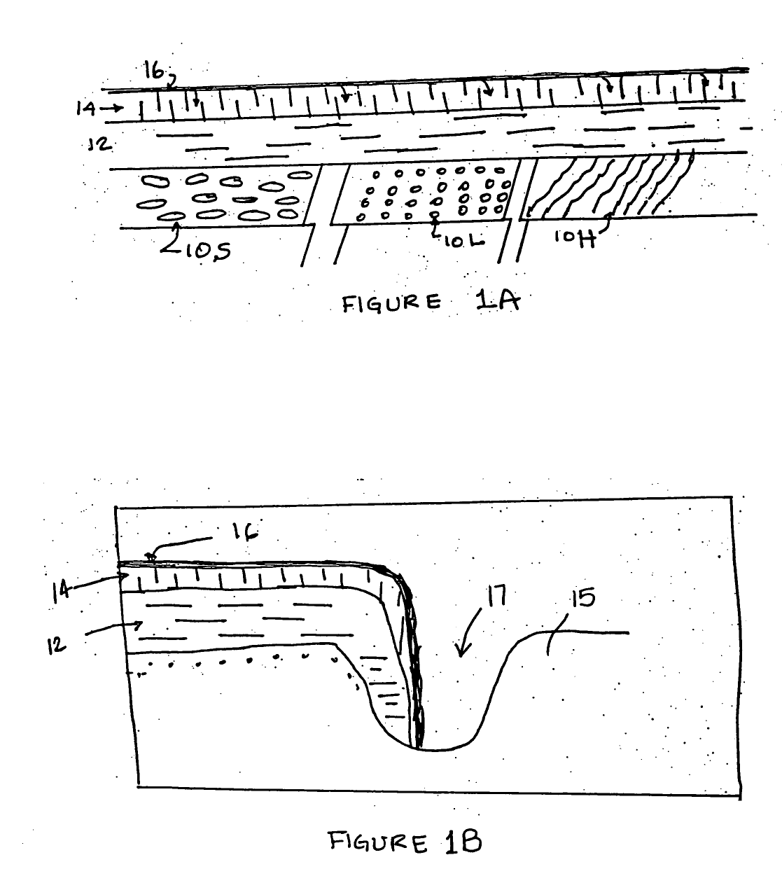

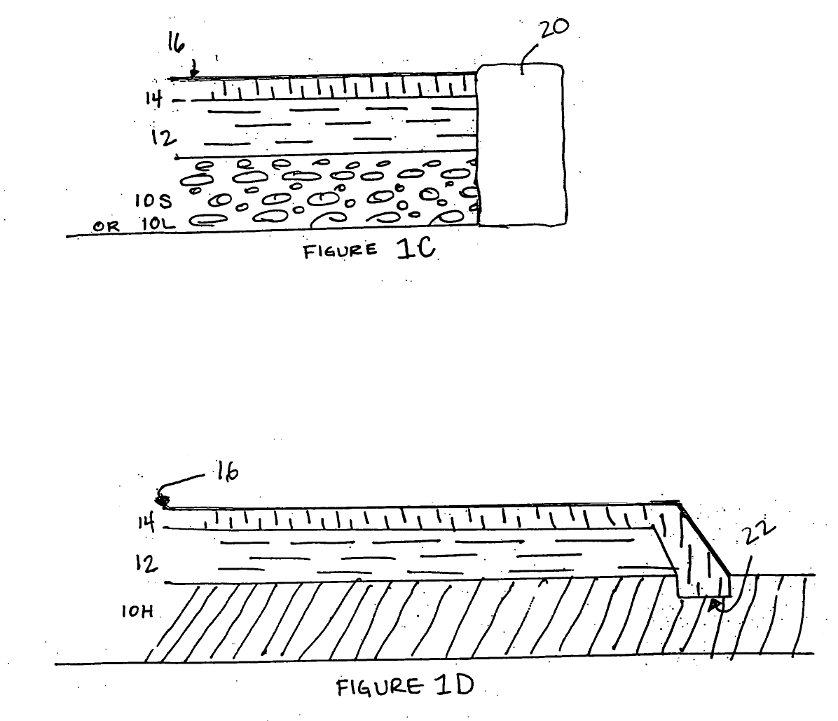

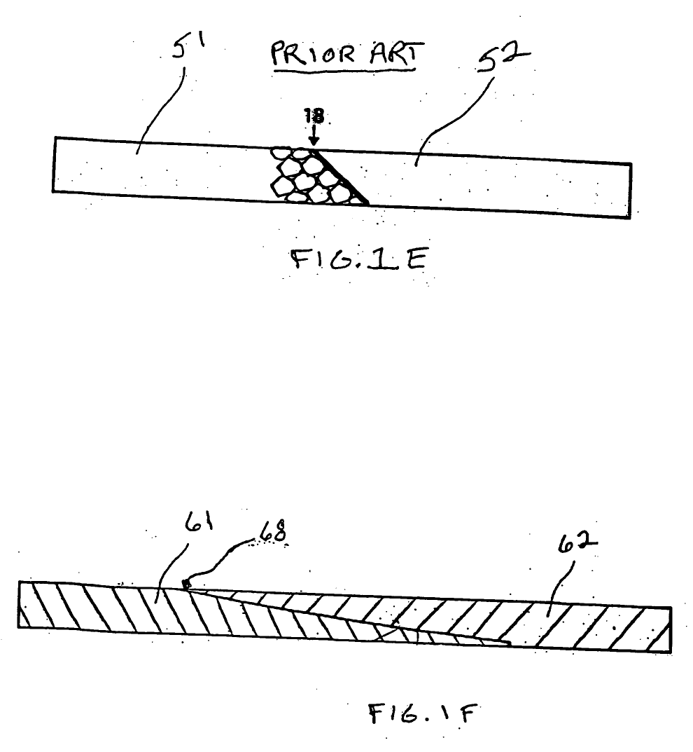

After the binder and the aggregate have been mixed, the resulting mixture is laid down in place over the base to form the shock-absorbing layer 12, illustrated in FIG. 1A, and allowed to cure by ambient air-drying, typically for 12-36 hours.

After the layer 12 has been cured, a wear-layer 14 is applied over the top of the layer 12. The wear-layer 14 also comprises a rubbery aggregate mixed with a low viscosity liquid polyurethane binder, preferably the low viscosity binder used in layer 12, but the pieces of elongated rubber used in the wear-layer 14 are sized smaller than those used in layer 12. The layer 14 comprises a rubbery aggregate used with a binder, wherein the binder is 19-23% of the total weight of the wear-layer 14, and the remainder of said wear layer is the rubbery aggregate. For example, the elongated rubber pieces in layer 14 are pieces that pass through an ASTM #8 screen but are retained by an ASTM #16 screen. An ASTM #8 screen is a 8 mesh screen (64 holes per sq/in). An ASTM #16 screen is a 14 mesh (196 holes per sq/in).

Although different sizes of rubber particles can be used in practicing the invention, it is an important feature of the invention that the length and width of the rubber pieces used in the shock-absorber layer 12 are sized larger than the length and width of the rubber pieces used in the wear-layer 14, to thereby improve the overall performance of the system in passing various fall tests, oftentimes required for use under children's playground equipment, such as, for example, the ASTM-F 1292-04 and F-355-01 tests.

As an additional feature, the multi-layer system illustrated in FIG. 1A can be laid over rubber gravel of various sizes, typically ranging in chunk sizes between 2 mm and 2 inches in size. the rubber gravel adds additional shock absorbency to the system, but can be used under the multi-layer system without resort to using an underlying concrete pad because of the strength of the system-according to the invention. The use of the rubber gravel also makes the use of the system more affordable by not requiring the use of a concrete pad. As an important feature of the invention, because the rubber gravel is less dense than rock gravel, the rubber gravel tends to stay on top of the dirt upon which it lays, and thus continues to provide additional shock absorbency.

After the wear-layer 14 has been laid over the top of the shock-absorber layer 12, and has been allowed to cure by ambient air-drying, typically for 12-36 hours, a coating 16, preferably an acrylic polymer, is applied over the top of the porous wear layer 14, and is allowed to percolate into the layer 14, thus filling some of the voids in the wear-layer 14. Because the acrylic coating 16 is water-based, heated air can be used to cure the coating. As an alternative, the coating 16 can also be polyurethane.

Although the system according to the invention can be used with various dimensions, a typical such system will be made to result in a total thickness of 4 inches (layers 12 and 14 and coating 16 together being 2 inches), installed over a 2-inch thickness of rubber gravel. The preferred makeup of the layers 12 and 14 typically being 1.5 inches thick (layer 12) and 0.5 inch thick (layer 14).

The acrylic polymer coating 16 reflects the UV rays from the sun, thus keeping the surface temperature of the system to a minimum (protecting bare feet of children) and also protects the polyurethane binder from UV degradation.

Referring now to FIG. 1B, there is a diagrammatic view of the same layers 12 and 14, having a top coating 16, which is illustrated in FIG. 1B as being used on top of dirt 15. A trough 17 is first dug in the dirt, around the periphery of the system having the layers 12 and 14, and the coating 16. In using this process, after the layers 12 and 14 are in place and the coating 16 has been allowed to dry, then the trough 17 can be back-filled, preferably with dirt, to leave no exposed edges.

Referring now specifically to FIG. 1C, an embodiment of the invention is illustrated as having a curb 20 which surrounds, partially or completely, a base of soft (10S) or loose (10C) materials. The curb 20 can be of various materials, for example, concrete, wood, plastic, rubber, or combinations thereof. The curb 20 may be already in place, or may be installed to help maintain the soft or loose base materials in place under the layered system according to the invention.

Referring now to FIG. 1D, an embodiment of the invention is illustrated, which functions quite well when used over a hard base (10H). In FIG. 1D, the wear layer 14, having a coating 16, uses a squared bottom trough 22 formed in the base 10H and the wear layer 14 is formed to fit in the trough 22, to thereby limit the exposure of the edges of the wear-layer 14. Thus, it should be appreciated that, various embodiments of systems are illustrated and described herein which can be used to curb the base material and/or to control the exposure of the edges of the multiple layer system of the invention, and such systems can be used interchangeably, or in combination, on each type of the base materials described herein, whether soft, hard, loose-fill, or combinations thereof.

Referring now to FIGS. 1E and 1F, another important feature of the invention involves the ability to return to an unfinished job and finish it up without leaving undesirable weak seams.

It is fairly common for jobs to be interrupted due to the weather, darkness, equipment failure, shortage of materials, etc. In any of such events, workers oftentimes have had to leave the job and return 6-8 hours later. When the job is resumed, weak seams and the inevitable repair of such weak seams are often the results. This problem has been resolved because, by using the properly sized and shaped rubber pieces according to the invention, coupled with a low viscosity binder in the wear-layer, the workers can return to the unfinished job, and by feathering the otherwise present weak seams, the low viscosity binder penetrates through the pores of the two overlapping feathered layers which permanently binds them into a single layer, no weak seam. This eliminates the weak seam problem, making for easy and strong repairs, and also allows the workers to patiently focus on workmanship instead of hurriedly working to avoid seams. FIG. 1E illustrates the prior art layers 51 and 52, which would otherwise cause a weak seam 18, but which with the feathering approach of FIG. 1F, according to the invention, leaves no weak seam. The present invention, as illustrated in FIG. 1F, allows the ½ inch thick wear layer 61 to be featured over the ½ inch thick layer 62 and thus provide a strong seam 68. This feathering approach, creating a strong seam 68, could not be accomplished by the prior art systems because of the size and shape of the aggregate particles used in the prior art.

I claim:

1. An impact-absorbing, durable-surface, multi-layer system for use on children's playgrounds, comprising:
a shock-absorbing layer comprising a polyurethane binder and a first rubbery aggregate, said first aggregate comprising elongated rubber pieces sized to be of a given size range;
a wear-layer residing on top of said first shock-absorbing layer, said wear-layer comprising a polyurethane binder and a second polymeric aggregate, said second aggregate comprising elongated rubber pieces sized to be of a smaller size range than said given size range; and
an acrylic polymer coating overlaid on top of and percolating into said wear-layer.

2. The system according to claim 1, wherein the binder is 13-19% of the total weight of said shock-absorbing layer and the remainder of said shock-absorbing layer is the first rubbery aggregate.

3. The system according to claim 2, wherein the binder is 19-23% of the total weight of said wear-layer, and the remainder of said wear-layer is the second rubbery aggregate.

4. The system according to claim 1, wherein said first screen is a vibrating screen.

5. The system according to claim 4, wherein said second screen is a vibrating screen.

6. The system according to claim 1, wherein said first screen allows particles between ASTM #3 and ASTM #8 to be sequestered.

7. The system according to claim 1, wherein said second screen allows particles between ASTM #8 and ASTM #16 to be sequestered.

8. An impact-absorbing, durable-surface, multi-layer system for use on children's playgrounds, comprising:
a shock-absorbing layer comprising a polyurethane binder and a first rubbery aggregate, said first aggregate comprising elongated rubber pieces sized to be of a given size range;
a wear-layer residing on top of said first shock-absorbing layer, said wear-layer comprising a polyurethane binder and a second polymeric aggregate, said second aggregate comprising elongated rubber pieces sized to be of a smaller size range than said given size range; and
a polyurethane coating overlaid on top of and percolating into said wear-layer.

9. A method for forming a impact-absorbing, multiple layer system for use on children's playgrounds, comprising the steps of:
laying a first layer on children's playground, comprising a polyurethane binder and a first rubbery aggregate comprising elongated rubber pieces sized to be of a given size range;
curing the binder in said first layer;
laying a second layer on top of said first layer, comprising a polyurethane binder and a second rubbery aggregate comprising elongated rubbery pieces sized to be of a smaller size range than said given size range;
curing the binder in said second layer; and
applying a coating on top of said second layer.

10. The method according to claim 9, wherein said coating comprises an acrylic polymer.

11. The method according to claim 9, wherein said coating comprises polyurethane.

12. The method according to claim 9, including, in addition thereto, the step of providing a third layer of rubber gravel underneath said first layer.

13. The method according to claim 9, wherein in the event the laying of the second layer has been interrupted, for whatever the reason, the step of resuming the laying of the second layer by feathering the seam between the unfinished second layer and the beginning of the remainder of the second layer.
